(19) United States
(12) Patent Application Publication
(10) Pub. No.: US 2008/0188112 A1
(43) Pub. Date: Aug. 7, 2008

(54) ELECTRICAL CONNECTOR

(75) Inventors: De Siang JU, Anloku (TW); Chin Chi LIN, Anloku (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD, Anloku (TW)

(21) Appl. No.: 11/872,246

(22) Filed: Oct. 15, 2007

(30) Foreign Application Priority Data
Feb. 6, 2007 (CN) 200720048328.6
Feb. 6, 2007 (CN) 200720048335.6

(51) Int. Cl. H01R 4/50

(52) U.S. Cl. 439/342

(57) ABSTRACT

The present invention relates to an electrical connector, which includes an insulating body and a plurality of conductive terminals. The insulating body has a plurality of containing holes, and the insulating body is capable of taking elastic deformation when being pressed. Furthermore, each of the conductive terminals is contained in one of the containing holes, and each of the conductive terminals includes a first conductive terminals and a second conductive terminal contacting against each other. Particularly, the first conductive terminal includes a first holding arm for holding the second conductive terminal.

### BACKGROUND OF THE INVENTION

1. Field of the Invention

The present invention relates to an electrical connector, and more particularly, to an electrical connector for connecting an external electronic component to a circuit board. Furthermore, the electrical connector of the invention contacts against the external electronic component.

2. Description of the Prior Art

At present, the electrical connector for connecting an external electronic component to a circuit board includes an insulating body and a plurality of conductive terminals, and the insulating body is generally not elastic. Furthermore, each of the conductive terminals is configured in the insulating body and has an elastic arm conductively connecting to the external electronic component and a contacting end conductively connecting to the circuit board. When the external electronic component presses and connects to the electrical connector, the conductive terminals take elastic deformation for providing the conductive terminals with normal force against the external electronic component. In the present technique, the conductive terminals incline and protrude out of the insulating body. When the external electronic component presses and connects to the electrical connector, the elastic arm of each conductive terminal takes elastic deformation to ensure the conductive terminal electrically connecting to the external electronic component. However, because the conductive terminals incline and protrude out of the insulating body and stack with each other, when the external electronic component presses and connects to the conductive terminal, the distance between elastic arms of the conductive terminals becomes smaller, so as to enhance the noise between the conductive terminals. Furthermore, when violent vibration happened, the elastic arms may conductive connecting with each other to cause the electrical connector unstable and reduce the performance of the electrical connector. At the same time, because each conductive terminal has long elastic arm which inclines and protrudes out of the surface of the insulating body, when the conductive terminals are overly concentrated, the elastic arms interfere or conductive connect with each other. Accordingly, the arrangement of the conductive terminals of the prior art cannot be concentrated.

On the other hand, the insulating body of the prior art has a plurality of containing holes. The conductive terminal is unity and includes a fixed part fixed in the insulating body. The fixed part protrudes downwardly to form a soldering part soldering to the circuit board, and the fixed part protrudes upwardly to form a contacting part contacting with the external electronic component. The conductive terminals easily turn into elastic fatigue and unable to arrange closely through repeatedly bending. Because of the above-mentioned reasons, an electrical connector utilizing two terminals for electrically connecting was developed. For example, in U.S. Pat. No. 5,362,241, the elastically contacting between the external electronic component and the circuit board is realized through connection of a fixed terminal and a terminal capable of elastically moving. The electrical connector is not easy to generate elastic fatigue and can arrange closely, however, the material of the terminals of the electrical connector requires enough elasticity and good electric conductivity, and inevitably generates the certain elastic fatigue through repeatedly bending. So that the cost will be increased and the fine electrical connection between the electronic elements and the circuit board is disadvantageous to be achieved.

Therefore, a novel design of electrical connector is necessary to overcome the above-mentioned defects.

### SUMMARY OF THE INVENTION

A scope of the invention is to provide a new electrical connector for better electrical connection between the electronic elements and the circuit board.

For the above-mentioned purpose, the electrical connector of the invention includes an insulating body and conductive terminals. The insulating body has a plurality of containing holes for containing the conductive terminals. The conductive terminal includes a first conductive terminal and a second conductive terminal, and the first conductive terminal and the second conductive terminal cooperates with each other. The insulating body is an elastomer, and once the insulating body is pressed, it elastically deforms to provide the conductive terminals with the necessary elasticity. Wherein, at least one of the first conductive terminal and the second conductive terminal installs a holder arm to hold the other.

Compared with the prior art, the electrical connector of the invention elastic deforms when being pressed, so as to provide the conductive terminals with the necessary elasticity. Because the elasticity is provided by the insulating body, the conductive terminals can be made by material with less elasticity and better electric conductivity, so as to provide better electrical connection between the electronic elements and the circuit board. In addition, because the normal force needed between conductive terminals and the external devices is provided by the elastic deformation of the insulating body, the conductive terminals of the invention can be designed without the elastic arms protruding out of the insulating body, and the interference caused by the closely elastic arms can be avoided. Accordingly, the arrangement of the conductive terminals of the invention can be highly concentrated.

The advantage and spirit of the invention may be understood by the following recitations together with the appended drawings.

### BRIEF DESCRIPTION OF THE APPENDED DRAWINGS

FIG. 1 is a schematic diagram illustrating the electrical connector according to an embodiment of the invention.

FIG. 2 is a schematic diagram illustrating the conductive terminal according to the embodiment of the invention.

FIG. 3 is a schematic diagram illustrating the insulating body according to the embodiment of the invention.

FIG. 4 is a side view illustrating the electrical connector according to the embodiment of the invention.

FIG. 5 is a side view illustrating that the electrical connector connects with the chip module and the circuit board according to the embodiment of the invention.

FIG. 6 is a schematic diagram illustrating the electrical connector according to another embodiment of the invention.

FIG. 7 is a schematic diagram illustrating the electrical connector according to another embodiment of the invention.

FIG. 8 is a schematic diagram illustrating the conductive terminal according to the embodiment of the invention.

FIG. 9 is a schematic diagram illustrating the insulating body according to the embodiment of the invention.

FIG. 10 is a schematic diagram illustrating the electrical connector according to another embodiment of the invention.

FIG. 11 is a schematic diagram illustrating the electrical connector connecting an external electronic component and a circuit board according to the embodiment of the invention.

FIG. 12 is a side view illustrating the conductive terminals according to the embodiment of the invention.

FIG. 13 is a side view illustrating the electrical connector according to another embodiment of the invention.

### DETAILED DESCRIPTION OF THE INVENTION

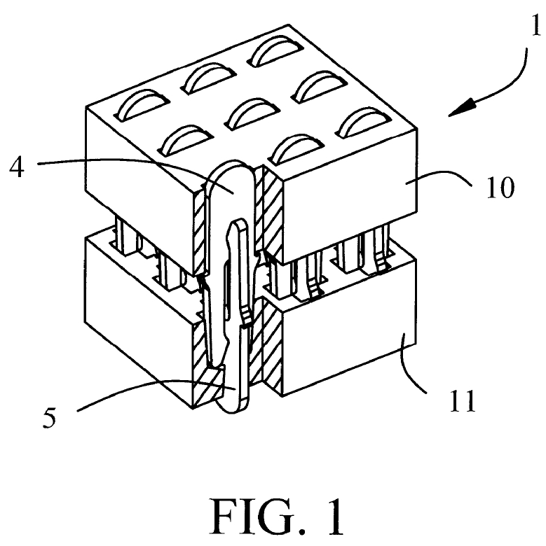

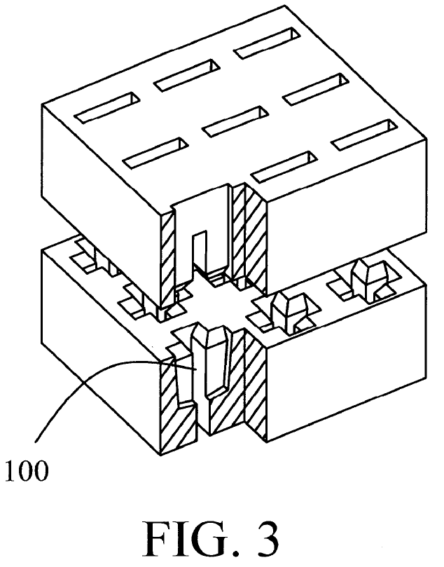

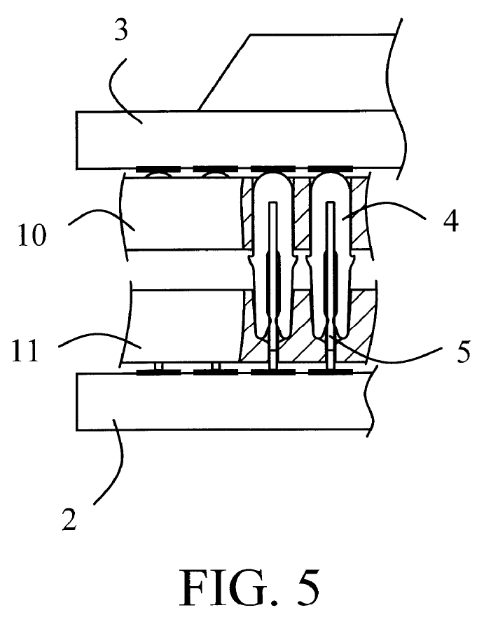

Please refer to FIG. 1 to FIG. 5. An electrical connector 1 of the present invention can electrically connect between a circuit board 2 and a chip module 3 (certainly, the chip module can be replaced by circuit board or other electronic element). The electrical connector 1 includes an insulating body and a plurality of conductive terminals. The insulating body includes a first insulating body 10 and a second insulating body 11. Furthermore, each of the conductive terminals includes a first conductive terminal 4 and a second conductive terminal 5. Wherein, the insulating body 10 has a plurality of containing holes 100 (as shown in FIG. 3), and the first conductive terminal 4 is contained in containing hole 100 of the first insulating body 10 and the second conductive terminal 5 is contained in containing hole 100 of the second insulating body 11. The insulating body can be an elastomer and can take elastic deformation. When the conductive terminals are pressed, the elastomer elastically deforms and generates a reacting force on the conductive terminals, and the reacting force is regarded as the normal force between the conductive terminals and the chip module 3 or between the conductive terminals and the circuit board 2. Accordingly, the elastomer provides the conductive terminals with the necessary elasticity to achieve the purpose of increasing the normal force, when being pressed. When at least one of the conductive terminals is moving (in the embodiment, both of the conductive terminals 4 and 5 move relatively at the same time), the first conductive terminal 4 and the second conductive terminal 5 form electrical conduction.

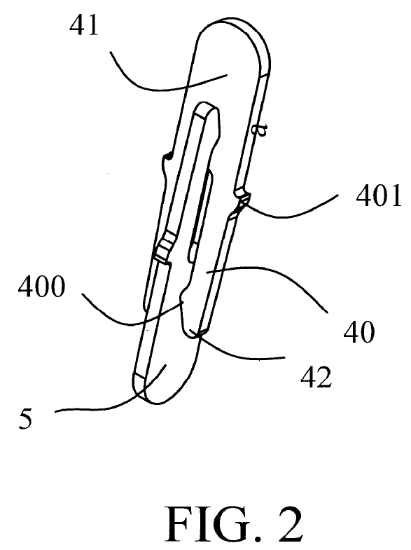

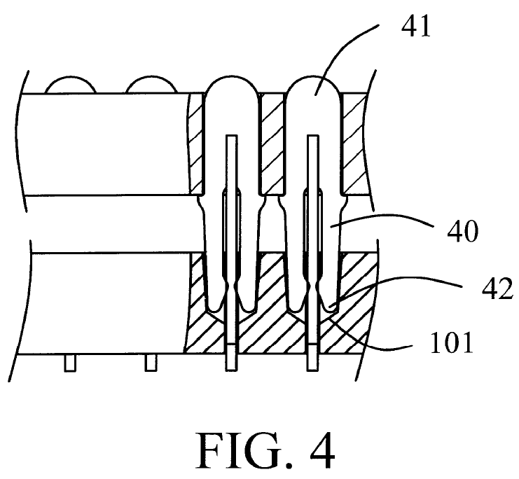

As shown in FIG. 2 and FIG. 4, the first conductive terminal 4 and the second conductive terminal 5 can move relatively, and at least one of the first conductive terminal 4 and the second conductive terminal 5 clips and holds the other (in this embodiment, the conductive terminals 4 and 5 clip and hold with each other, and are perpendicular and cross with each other). The lateral size of at least one of the first conductive terminal 4 and the second conductive terminal 5 is larger than the size of the containing hole (in the embodiment, the size of both conductive terminals are larger than the size of the containing hole) Wherein, the first conductive terminal 4 includes a pair of first holding arms for clipping and holding the second conductive terminal 5, a first conducting part 41 upwardly extended from the first holding arm 40, and a first stop part 42 downwardly extended from the first holding arm 40. Wherein, the end of the first holding arm 40 near the first stop part 42 protrudes inwardly to form a first contacting part 400 for clipping and holding the second conductive terminal 5, and the other end opposite to the first contacting part 400 protrudes outwardly to form a first limit part 401 for preventing the first conductive terminals 4 from overly moving. In the embodiment, both of the conductive terminals 4 and 5 have the same structure, and discussion of the details will be omitted. The first conductive terminal 4 can be inserted into the containing holes 100 of the second insulating body 11 for clipping and holding the corresponding second conductive terminal 5 with each other. The second conductive terminal 5 can be inserted into the containing holes 100 of the first insulating body 10 for clipping and holding the corresponding first conductive terminal 4 with each other. The above-mentioned containing holes 100 have a ramp for the conductive terminals to move. When the conductive terminals are forced to move downwardly, the side walls of the containing holes 100 can compress the holding arms, and the holding arms receives the pressure from the side walls to make the first conductive terminals 4 and the second conductive terminals 5 to clip and hold tightly, so as to achieve electrical connection. And then, the electrical connection between chip module 3 and the circuit board 2 is achieved.

The electrical connector of the invention provides the elasticity through the insulating body, so that the conductive terminals can be made by material with less elasticity and better electric conductivity, and the better electrical connection between the chip module and the circuit board can be realized, furthermore, the purpose of cost saving can be achieved.

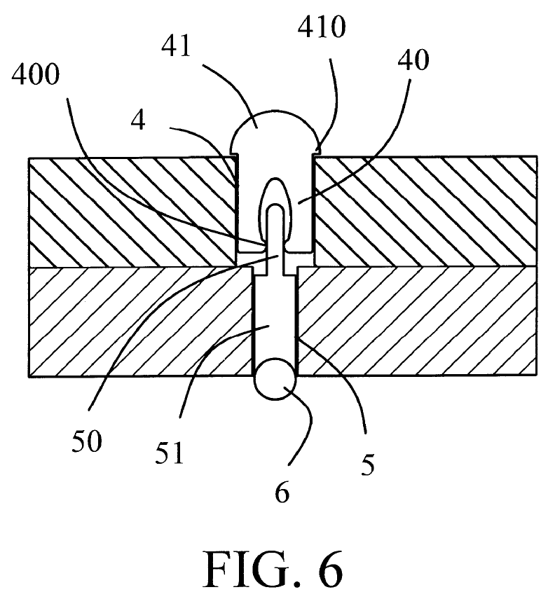

Please refer to FIG. 6. FIG. 6 shows another embodiment of the invention. The first conductive terminal 4 includes the holding arm 40 capable of clipping and holding the second conductive terminal 5, and the conducting part 41 upwardly extended from the holding arm 40. The holding arm 40 protrudes inwardly to form a contacting part 400 capable of holding the second conductive terminal 5, and the conducting part 41 has a limiting part 410 preventing the first conductive terminal 4 from overly moving downwardly. The second conductive terminal 5 includes an inserting part 50 cooperated with the contacting part 400, and a soldering part 51 downwardly extended from the inserting part 50. A solder ball 6 is configured on the soldering 51 and can solder the second conductive terminal 5 to the circuit board (not shown). Similarly, the embodiment can achieve the above-mentioned effect.

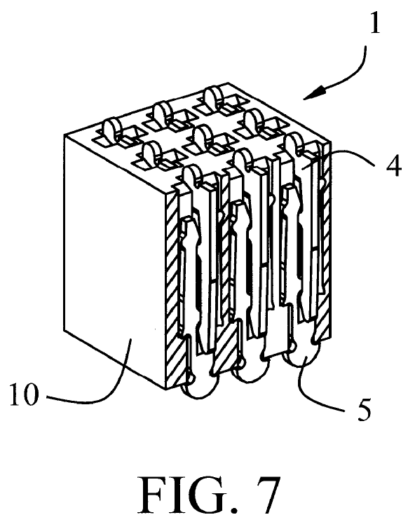

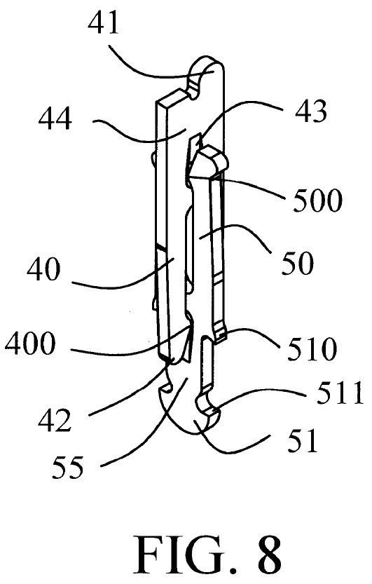

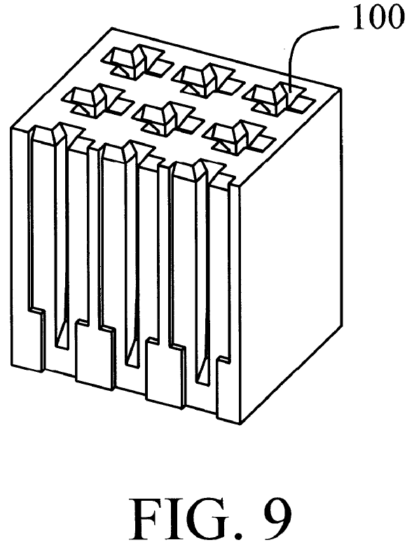

Please refer to FIG. 7, FIG. 8, and FIG. 9. These figures show another embodiment of the invention. The electrical connector 1 has only one insulating body 10. The insulating body 10 also has a plurality of containing holes 100, and the first conductive terminal 4 and the second conductive terminal 5 connected with each other are configured in each of the containing holes 100. The first conductive terminal 4 includes a first main part 44; the first holding arm 40, for holding the second conductive terminal 5, downwardly protruded from the sides of the first main part 44; the first conducting part 41 upwardly extended from the first main part 44; and the first stop part 42 downwardly extended from the first holding arm 40. One end of the first holding arm 40 near the stop part 42 protrudes inwardly to form the first contacting part 400 capable of holding the second conductive terminal 5. Furthermore, the second conductive terminal 5 includes a second main part 55; the second holding arm 50, for holding the first conductive terminal 4, upwardly protruded from the sides of the second main part 55; and the second conducting part 51 downwardly extended from the second main part 55. One end of the second holding arm 50 protrudes inwardly to form a second contacting part 500, and both ends of the second main part 55 oppositely form second stop parts 510. Moreover, both sides of the second conducting part 51 protrude to form limit parts 511 capable of preventing the second conductive terminal 5 from being pressed into the limit parts 511 of the insulating body 10. The main parts 44 and 55 of the conductive terminals 4 and 5 form fillisters 43 for wedging the contacting parts of the corresponding conductive terminals, so that the conductive terminals 4 and 5 can be prevented from departing from each other and getting away from the containing hole 100. The fillister 43 is configured from shallow to deep on the main part, so that the holding force between the conductive terminals 4 and 5 can be increased gradually during the moving of the conductive terminals 4 and 5, so as to provide better contact. At the same time, the conductive terminals 4 and 5 are wedged in the mutual fillisters 43 for preventing the conductive terminals from getting away from the insulating body. The lateral walls of the containing holes 100 compress the holding arms 40 and 50 during the deformation of the elastomer, so that the contact force will be increased and then the better electric conductivity can be achieved. The embodiment can provide the same effect of the above-mentioned embodiment.

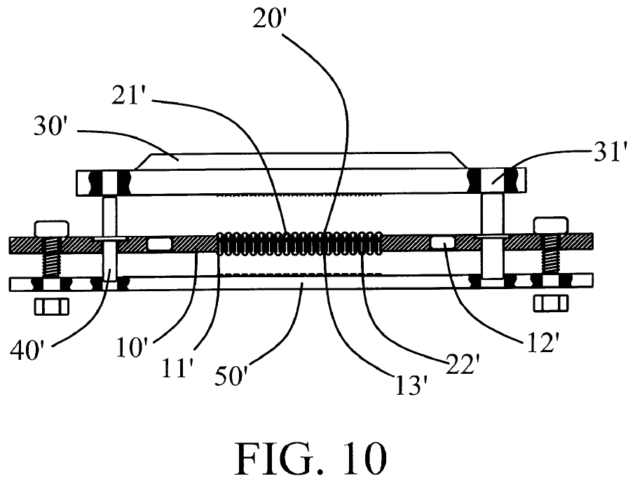

Please refer to FIG. 10. The electrical connector 1′ of the invention is applied for connecting an external electronic component 3′ and a circuit board 2′, and includes an insulating body 10′ and a plurality of conductive terminals 20′.

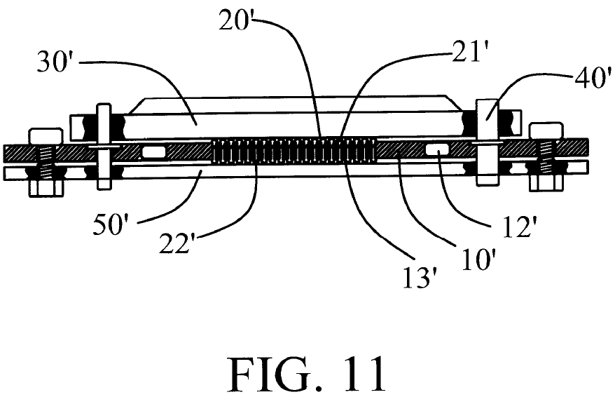

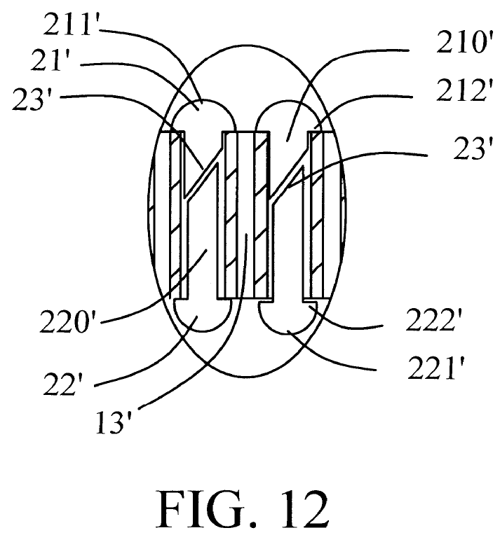

Please refer to FIG. 11 and FIG. 12. The insulating body 10′ has a plurality of containing holes 100′ for containing the conductive terminals 20′. Each of the conductive terminals 20′ includes a first conductive terminal 21′ and a second conductive terminal 22′, and the first conductive terminal 21′ and the second conductive terminals 22′ electrically connect respectively to the external electronic component 3′ and the circuit board 2′. The first conductive terminal 21′ is configured above the second conductive terminals 22′, and the first conductive terminal 21′ and the second conductive terminals 22′ can press and contact with each other.

The first conductive terminal 21′ and the second conductive terminals 22′ form a first main part 210′ and a second main part 220′ respectively, and the first main part 210′ and the second main part 220′ form an inclined contacting surface 23′ respectively, wherein the two contacting surface 23′ are configured oppositely. When the external electronic component 3′ connects to the electrical connector 1′, these inclined contacting surfaces are capable of sliding contact with each other to make the first and the second conductive terminals 21′ and 22′ press and contact with each other. The first and the second conductive terminals 21′ and 22′ respectively form a first contacting part 211′ and a second contacting part 221′ extended from the first main part 210′ and the second main part 220′ respectively. Furthermore, the first and the second contacting part 211′ and 221′ can electrically connect to the external electronic component 3′ and the circuit board 2′. The first and the second conductive terminals 21′ and 22′ form a first and a second holding parts 212′ and 222′ extended from the first and the second main part 210′ and 220′ toward both sides of the containing hole 11′ respectively, and the first and the second holding parts 212′ and 222′ can hold on the surface of the insulating body 10′. When the external electronic component 3′ connects to the electrical connector 1′, the holding parts 212′ and 222′ hold on the insulating body 10′ to make the insulating body 10′ to elastically deform under the pressure of the external electronic component 3′.

The electrical connector 1′ further includes a blocking structure 12′ and a fixing guiding structure 40′, and the blocking structure 12′ can be configured in the insulating body 10′ or form a unity with the fixing guiding structure 40′. The blocking structure 12′ can prevent the external electronic component 3′ from overly compressing the insulating body 10′ to make the conductive terminals to be permanent distortion. The fixing guiding structure 40′ can fix the external electronic component 3′ to the electrical connector 1′, and guide the insert direction of the external electronic component 3′ to make the contacting point of the external electronic component 3′ to contact with the contacting part 212′ accurately.

A space is configured between the adjacent containing holes 11′ to form placing space 13′ for containing the elastic deformation of the insulating body 10′. When the insulating body 10′ elastically deforms, the insulating body 10′ between the containing holes 11′ generate a curved elastic deformation, and the placing space 13′ provides a deformation space for the elastic deformation of the insulating body 10′, so as to increase the elasticity of the insulating body 10′.

The invention utilize the elasticity of the insulating body 10′ to provide the normal force between the conductive terminals 20′ and the external electronic component 3′, and prevent the inclined elastic arms configured on the conductive terminals 20′, so as to decrease the noise interference between the conductive terminals 20′ and increase the performance of the electrical connector 1′. Furthermore, the conductive terminal 20′ is configured upright in the insulating body 10′ to be advantageous for the high concentration of arrangement.

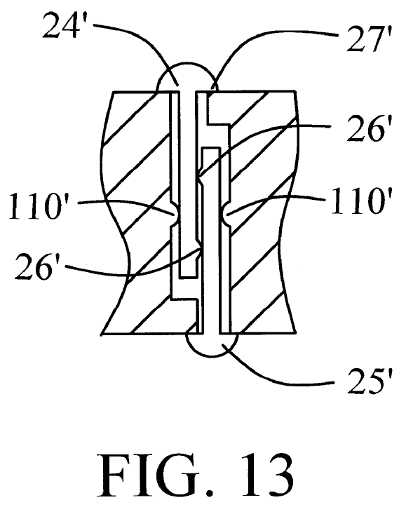

Please refer to FIG. 13. FIG. 13 show another embodiment and the difference between this embodiment and the above-mentioned embodiment is that the first and the second conductive terminals 24′ and 25′ is partially stacked and closely in the containing hole 11′. The inner sides of first and the second conductive terminals 24′ and 25′ respectively form protruding parts 26′ capable of sliding contacting with each other. Two protruding parts 26′ respectively press and contact on the corresponding terminals 20′, and when the external electronic component 3′ press and contact the electrical connector 1′, the first and the second conductive terminals 24′ and 25′ slide along the pressing direction. Furthermore, the first and the second conductive terminals 24′ and 25′ electrically connect with the other through the protruding parts 26′.

The inner walls of the containing holes 11′ further form pressing parts 110′, when the external electronic component 3′ presses and contacts on the electrical connector 1′, the insulating body 10′ generates elastic deformation to make the pressing parts 110′ to press and contact the sides, near inner walls of the containing holes 11′, of the conductive terminals 20′, so as to make the first and the second conductive terminals 24′ and 25′ to connect tightly. The first and the second conductive terminals 24′ and 25′ form a limiting part 27′ to limit the conductive terminals 20′ on the insulating body 10′.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An electrical connector, comprising:
an insulating body having a plurality of containing holes, wherein the insulating body is capable of taking elastic deformation when being pressed; and
a plurality of conductive terminals, each of the conductive terminals being contained in one of the containing holes, and each of the conductive terminals comprising a first conductive terminals and a second conductive terminal contacting against each other, wherein the first conductive terminal comprises a first holding arm for holding the second conductive terminal.

2. The electrical connector of claim 1, wherein the second conductive terminal comprises a second holding arm for holding the first conductive terminal.

3. The electrical connector of claim 2, wherein the first holding arm and/or the second holding arm inwardly have a contacting part capable of holding the second conductive terminal and/or the first conductive terminal.

4. The electrical connector of claim 2, wherein the end of the first holding arm and/or the second holding arm have a stop part capable of touching against the insulating body.

5. The electrical connector of claim 1, wherein the first holding arm and/or the second holding arm inwardly have a contacting part capable of holding the second conductive terminal and/or the first conductive terminal.

6. The electrical connector of claim 1, wherein the end of the first holding arm and/or the second holding arm have a stop part capable of touching against the insulating body.

7. The electrical connector of claim 1, wherein each of the conductive terminals has a limiting part for preventing the conductive terminals from overly moving.

8. The electrical connector of claim 1, wherein each of the first conductive terminals is perpendicular and cross the second conductive terminal against by the first conductive terminal.

9. The electrical connector of claim 1, wherein the second conductive terminal comprises an inserting part cooperating with the second holding arm and a soldering part extending from the inserting part.

10. The electrical connector of claim 1, wherein the first conductive terminal comprises a main part, and one end of the main part extending to form the first holding arm and the other end of the main part extending to form a conducting part to contact with an electronic element.

11. The electrical connector of claim 10, wherein the main part hollows inwardly to form a fillister.

12. The electrical connector of claim 11, wherein the fillister is configured at the sides of the main part, and the fillister being configured from shallow to deep.

13. The electrical connector of claim 1, wherein the containing hole provides a ramp for the conductive terminal to move.

14. The electrical connector of claim 1, wherein each of the first conductive terminal and the second conductive terminal has an inclined contacting surface capable of sliding contacting each other.

15. The electrical connector of claim 1, wherein the first conductive terminal and the second conductive terminal are partially stacked each other and approach each other in the containing hole.

16. The electrical connector of claim 15, wherein the first conductive terminal and/or the second conductive terminal protrudes to form a protruding part capable of sliding contacting along each other.

17. The electrical connector of claim 15, wherein an inner wall of the containing hole has a pressing part respectively contacting and holding the conductive terminal.

18. The electrical connector of claim 1, further comprising a blocking structure capable of preventing the insulating body from over deformation.

19. The electrical connector of claim 1, wherein a placing space is configured between the adjacent containing holes for containing the elastic deformation of the insulating body.

20. The electrical connector of claim 1, wherein the insulating body comprises a first insulating body containing the first conductive terminal and a second insulating body containing the second conductive terminal, wherein the first insulating body and/or the second insulating body are capable of taking elastic deformation.
